(19) United States
(12) Patent Application Publication
(10) Pub. No.: US 2008/0240580 A1
(43) Pub. Date: Oct. 2, 2008

(54) VIDEO CLASSIFYING DEVICE

(76) Inventors: Masaru Sugano, Saitama (JP); Yasuhiro Takishima, Saitama (JP)

Correspondence Address: WESTMAN CHAMPLIN & KELLY, P.A., SUITE 1400, 900 SECOND AVENUE SOUTH, MINNEAPOLIS, MN, 55402-3244, US

(21) Appl. No.: 12/053,779

(22) Filed: Mar. 24, 2008

(30) Foreign Application Priority Data
Mar. 28, 2007 (JP) 2007-084710

(51) Int. Cl. G06K 9/62

(52) U.S. Cl. 382/224

(57) ABSTRACT

A video analyzing unit 1 analyzes features of an input video. A video classifying unit 2 estimates, based on results of an analysis by the video analyzing unit 1, whether the input video is one shot by a professional cameraman or one shot by an amateur to carry out classification. The video analyzing unit 1 includes a shot density measuring unit 11, a camera-shake determining unit 12, a blur determining unit 13, and a contrast measuring unit 14. Further, a sound analyzing unit that analyzes features of a sound accompanying the input video can be provided to use results of an analysis thereof as information for video classification.

The present application is claims priority of Japanese patent application Serial No. 2007-084710, filed Mar. 28, 2007, the content of which is hereby incorporated by reference in its entirety.

### BACKGROUND OF THE INVENTION

1. Field of the Invention

The present invention relates to a video classifying device, and particularly, to a video classifying device that classifies a video by estimating whether the video was shot by a professional cameraman or was shot by an amateur.

2. Description of the Related Art

Illegal uploading of a video on a video sharing site that was shot by a professional cameraman and broadcast on a TV program has become a problem. It is desirable that such uploaded video is immediately deleted at a stage where it has turned out to be piracy, and for assistance thereof, a video classifying device that classifies a video by estimating whether the video was shot by a professional cameraman or was shot by an amateur is demanded.

Non-Patent Document 1 discloses a technique which is, for a still image (photograph), for classifying the image by estimating whether it is a photograph taken by a professional cameraman or a photograph taken by an amateur. Here, a spatial distribution of an edge part in the photograph, a color distribution, the number of color tones, blur, contrast, and brightness are determined by means of a Bayesian classifier, and it is estimated, based on results of this determination, whether the photograph was taken by a professional cameraman or was taken by an amateur to carry out classification.

It has also been known to assess an image from the perspective of an exposure condition, contrast, blur, and a camera shake state. For example, in Patent Document 1, it has been described to assess an already-recorded image from the perspective of an exposure condition, contrast, blur, and a camera shake state and determine a candidate of an image to be deleted from a recording medium based on results of this assessment, in an image shooting device such as a digital camera, when a remaining capacity of the recording medium is small.

[Patent Document 1] Japanese Published Unexamined Patent Application No. 2006-50497

[Non-Patent Document 1] “The Design of High-Level Features for Photo Quality Assessment,” IEEE International Conference on Computer Vision and Pattern Recognition 2006.

The technique disclosed in Non-Patent Document 1 is only for a still image, and when this is applied to classification of a video as it is, since none of the video features regarding a difference between a professional cameraman and an amateur is used, there is a problem that the classifying accuracy is inferior.

The technique disclosed in Patent Document 1 intends to delete an unnecessary image from the images recorded on the recording medium of a digital camera and does not intend to classify an image by estimating whether the image is one taken by a professional cameraman or one taken by an amateur.

There is no technique that is known, for a video, for classifying the video by estimating whether it was shot by a professional cameraman or was shot by an amateur by using video features regarding a difference between a professional cameraman and an amateur.

### SUMMARY OF THE INVENTION

It is an object of the present invention to provide a video classifying device that classifies a video by accurately estimating whether the video was shot by a professional cameraman or was shot by an amateur.

In order to accomplish the object, the first feature of this invention is that a video classifying device comprises, a video analyzing means that analyzes features of an input video, and a video classifying means that estimates, based on results of an analysis by the video analyzing means, whether the input video is one shot by a professional cameraman or one shot by an amateur to carry out classification, wherein the video analyzing means includes at least one of a shot density measuring means that measures a shot density in the input video and a camera-shake determining means that determines whether camera shake exists.

The second feature of this invention is that the video analyzing means further includes at least one of a blur determining means that determines whether blur of a picture exists and a contrast measuring means that measures contrast.

The third feature of this invention is that the video analyzing means includes the shot density measuring means, and the shot density measuring means consists of a means that detects shot boundaries and a means that counts a number of shots thus detected per unit time.

The fourth feature of this invention is that the video analyzing means includes the camera-shake determining means, and the camera-shake determining means assesses a motion direction and a motion magnitude between an input frame and a frame temporally ahead of the input frame and determines that camera shake exists, when a number of observed frames that satisfy a condition that a distribution of motion directions is smaller than a present first threshold value and satisfy at least one of the conditions that an average of motion magnitudes is smaller than a preset second threshold value and a distribution of motion magnitudes is smaller than a preset third threshold exceeds a preset fourth threshold value.

The fifth feature of this invention is that the video analyzing means includes the blur determining means, and the blur determining means applies a two-dimensional frequency transform to each of the blocks obtained by dividing the picture into a plurality of blocks and determines that blur exists, when a ratio of the number of blocks having a predetermined value or less of energy in a preset high frequency band to the number of all blocks is greater than a preset fifth threshold value.

The sixth feature of this invention is that the video analyzing means includes both the shot density measuring means and the camera-shake determining means, and the video classifying means estimates, when the shot density measured by the shot density measuring means is equal to or more than a predetermined threshold value per unit time and it is determined by the camera-shake determining means that no camera shake exists, that the input video is one shot by a professional cameraman to carry out classification.

The seventh feature of this invention is that the video analyzing means includes at least one of the shot density measuring means and the camera-shake determining means and at least one of the blur determining means and the contrast measuring means, and the video classifying means estimates, when it is determined by at least one of the shot density measuring means and the camera-shake determining means that the shot density is equal to or more than a predetermined threshold value per unit time or no camera shake exists and it is determined by at least one of the blur determining means and the contrast measuring means that no blur exists or the contrast is equal to or more than a predetermined threshold value, that the input video is one shot by a professional cameraman to carry out classification.

The eighth feature of this invention is that further comprises a sound analyzing means that analyzes features of a sound accompanying the input video, wherein the video classifying means estimates, using results of an analysis by the sound analyzing means besides the results of an analysis by the video analyzing means, whether the input video is one shot by a professional cameraman or an amateur to carry out classification.

The ninth feature of this invention is that the sound analyzing means includes at least one of a sound/silence determining means that determines whether a sound exists, a noise determining means that determines whether noise exists, and a background music determining means that determines whether background music exists.

The tenth feature of this invention is that the sound analyzing means includes the noise determining means, and the noise determining means determines, when having detected that a sound exists and having classified the sound as noise, that noise exists.

The eleventh feature of this invention is that the sound analyzing means includes the background music determining means, and the background music determining means determines, when having detected that a sound exists and having classified the sound as noise, that background music exists.

The twelfth feature of this invention is that the sound analyzing means includes the sound/silence determining means, and the video classifying means estimates, when it is judged by the sound/silence determining means that the sound accompanying the input video does not exist in a previously specified time interval, that the input video is one shot by an amateur to carry out classification.

The thirteenth feature of this invention is that the video classifying means estimates, when it is determined by the noise determining means that the sound accompanying the input video includes noise, that the input video is one shot by an amateur to carry out classification.

The fourteenth feature of this invention is that the video classifying means estimates, when it is determined by the background music determining means that the sound accompanying the input video includes background music, that the input video is one shot by a professional cameraman to carry out classification.

The fifteenth feature of this invention is that the video classifying means is a learning machine in which classification criteria of video features for classifying the input video as one shot by a professional cameraman or one shot by an amateur are preset by learning.

The sixteenth feature of this invention is that the video classifying means is a learning machine in which classification criteria of video features and sound features for classifying the input video as one shot by a professional cameraman or one shot by an amateur are preset by learning.

In the present invention, features unique to a video and features of a sound accompanying the video are analyzed, and whether the input video is one shot by a professional cameraman or one shot by an amateur is estimated to carry out classification, and thus a video shot by a professional cameraman using a professional-quality camera for a TV broadcast or for a film and a video shot by an amateur using, for example, a camcorder or a mobile phone camera can be classified with accuracy.

Since videos shot by professional cameramen are commonly accompanied by copyrights, even in the case of, for example, illegal uploading of a video shot by a professional cameraman by a user on a video sharing site and the like, it can be immediately detected and a copyright protection can be demanded.

### BRIEF DESCRIPTION OF THE DRAWINGS

FIG. 1 is a functional block diagram showing a first embodiment of a video classifying device according to the present invention.

FIG. 2 is a view showing a concrete example indicating a state of shot change in a video according to shooting by a professional cameraman and an amateur.

FIG. 3 is a flowchart showing an example of a process of determining whether camera shake exists.

FIG. 4 is a view showing a concept of determining whether blur exists.

FIG. 5 is a flowchart showing an example of a process of determining whether blur exists.

FIG. 6 is a functional block diagram showing a second embodiment of a video classifying device according to the present invention.

FIG. 7 is a functional block diagram showing a third embodiment of a video classifying device according to the present invention.

### DETAILED DESCRIPTION OF THE PREFERRED EMBODIMENTS

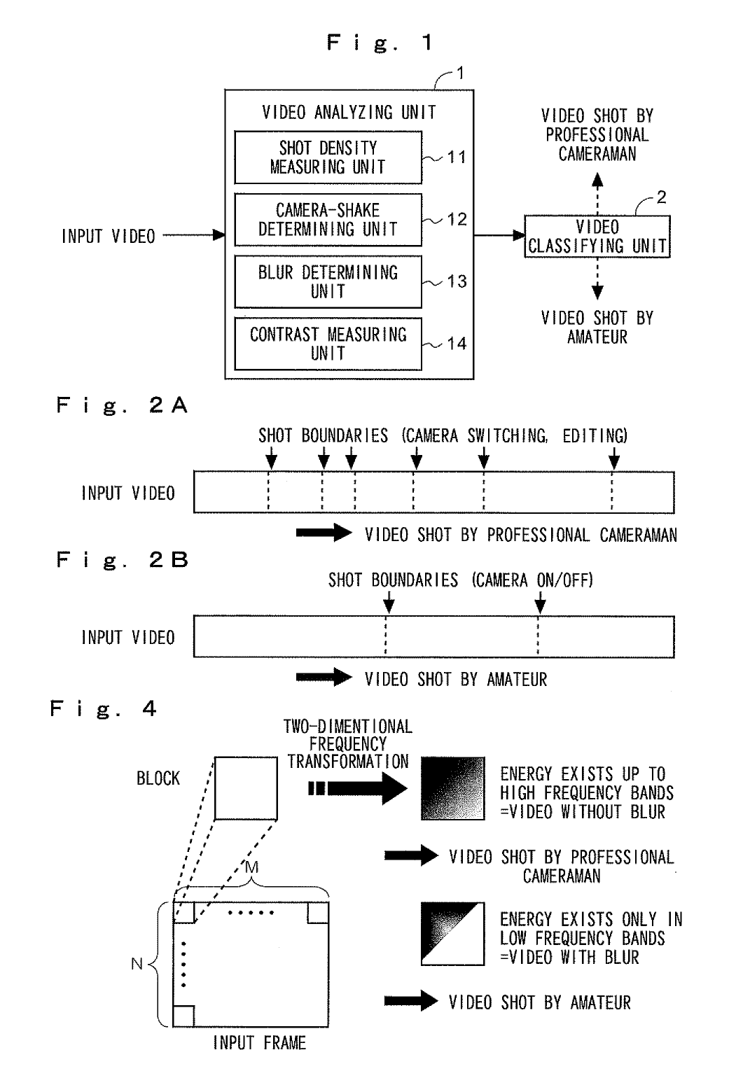

Hereinafter, the present invention will be described with reference to the drawings. FIG. 1 is a functional block diagram showing a first embodiment of a video classifying device according to the present invention. The video classifying device of the first embodiment includes a video analyzing unit 1 and a video classifying unit 2. These units can be realized either by hardware or by software.

The video analyzing unit 1 analyzes features included in an arbitrary input video. The features herein analyzed will be described later. The video classifying unit 2 estimates, based on results of the analysis by the video analyzing unit 1, whether the input video is one shot by a professional cameraman or one shot by an amateur to carry out classification.

The video analyzing unit 1 includes a shot density measuring unit 11, a camera-shake determining unit 12, a blur determining unit 13, and a contrast measuring unit 14, and mainly analyzes signal-like features of the input video. Here, the shot density and camera shake are features particularly effective in estimating whether the video is one shot by a professional cameraman or one shot by an amateur. It is therefore necessary for the video analyzing unit 1 to include at least either one of the shot density measuring unit 11 and the camera-shake determining unit 12, and the blur determining unit 13 and the contrast measuring unit 14 are added appropriately according to necessity. As a matter of course, an improvement in accuracy can be expected by increasing elements of the features that are analyzed in the video analyzing unit 1.

Hereinafter, the respective units of the video analyzing unit 1 will be described in detail. The shot density measuring unit 11 not only detects shot boundaries in a video but also measures the number of shots in a unit time. That is, the shot density measuring unit 11 measures a shot density. Also, for the detection of shot boundaries, a technique described in Japanese Published Unexamined Patent Application No. H10-224741 can be used. The unit time for which the number of shots is measured can be set to, for example, 60 seconds.

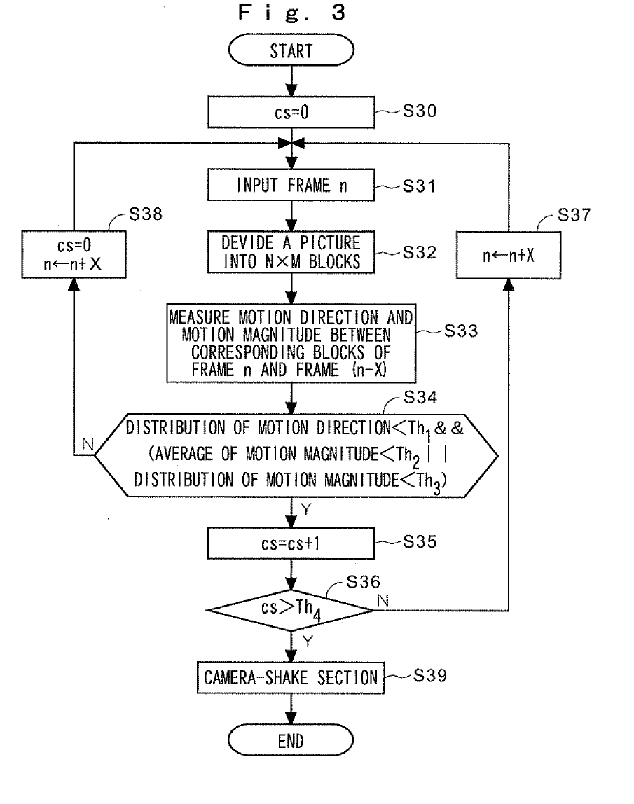

FIG. 2 is a view showing a concrete example indicating a state of shot change in a video according to shooting by a professional cameraman and an amateur. FIG. 2A shows shot boundaries in a video according to shooting by a professional cameraman, and FIG. 2B shows shot boundaries in a video according to shooting by an amateur.

A shot boundary is generally caused by turning on and off a camera, however, in a video shot by a professional cameraman, the shot boundary is also often inserted by switching cameras to shoot a subject during shooting or by editing after shooting. Therefore, it is highly likely that the video in which shot boundary frequently occurs is a video shot by a professional cameraman. On the other hand, in a video shot by an amateur, a shot boundary is generally caused only by turning on and off a camera. Therefore, the number of shots in a unit time serves as effective information in estimating whether the video was shot by a professional cameraman or was shot by an amateur.

The camera-shake determining unit 12 determines whether camera shake at the time of shooting exists in a video. Since camera shake occurs due to shaking and/or movement of shooter's hands, it is highly likely that the video including camera shake is a video shot by an amateur. Therefore, whether camera shake exists also serves as effective information in estimating whether the video was shot by a professional cameraman or was shot by an amateur.

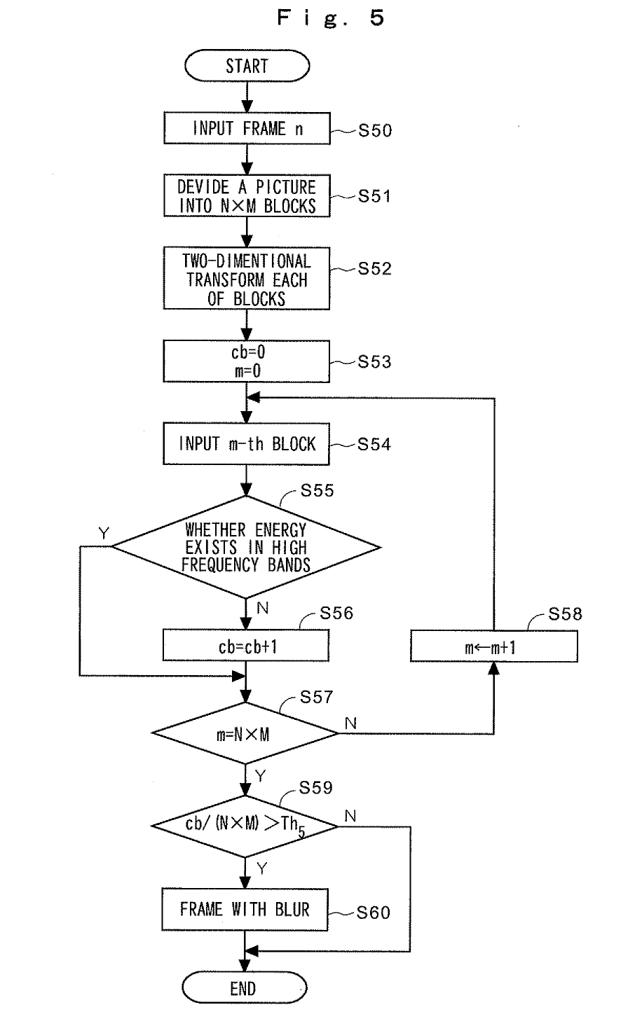

FIG. 3 is a flowchart showing an example of a process of determining whether camera shake exists. After initial setting (S30) of the number of frames cs to 0, a frame n of a video is inputted (S31), and a picture thereof is divided into N×M blocks (S32) Next, a motion direction and a motion magnitude between corresponding blocks are measured between the frame n and a frame (n−X) that is temporally X frames (X is an arbitrary number) ahead of said frame n (S33). This motion direction and motion magnitude can be measured by, for example, determining a motion vector between the corresponding blocks. In addition, it is assumed that a picture of the frame (n−X) has also already been divided into N×M blocks.

Next, it is determined whether a distribution of motion directions in the picture determined as in the above satisfies a condition of being smaller than a first threshold value Th1 and a condition concerning the motion amount (that is, at least either one of that an average of motion magnitudes is smaller than a second threshold value and that a distribution of motion magnitudes is smaller than a third threshold value) is satisfied (S34).

When it is determined in S34 that a distribution of motion directions satisfies the condition, cs is incremented by one (cs=cs+1) (S35). Then, it is determined whether cs has exceeded a fourth threshold value Th4 (S36), and when it is determined that cs has not exceeded the fourth threshold value Th4, the frame is provided as (n+X) (S37), and the flow returns to S31 to repeat the process.

When it is determined in S34 that a distribution of motion directions does not satisfy the condition, the number of frames as is set to 0, and moreover the frame is provided as (n+X) (S38) and the flow returns to S31 to repeat the process.

In addition, when it is determined in S36 that cs has exceeded the fourth threshold value Th4, it is determined that camera shake existed in an observation interval from the frame n until Cs exceeds the fourth threshold value Th4 (S39).

In the flowchart shown in FIG. 3, when the number of observed frames that satisfy the condition that a distribution of motion directions in the picture is smaller than the first threshold value Th1 and satisfy the condition concerning the motion magnitude exceeds the fourth threshold value Th4, it is determined that camera shake existed in this observation interval. This is provided as a result of determination as to whether camera shake exists in a video.

The method for determining whether camera shake exists is not limited to the method shown in FIG. 3, but other methods such as a technique disclosed in Japanese Published Unexamined Patent Application No. 2006-129074 can also be used.

The blur determining unit 13 determines whether blur at the time of shooting exists in a video. Blur at the time of shooting occurs in a video when a subject is out of focus. It is highly likely that the video including blur is a video shot by an amateur. Therefore, whether blur exists can also be used for estimating whether the video was shot by a professional cameraman or was shot by an amateur.

Whether blur at the time of shooting exists in a video is determined by assessing frequency characteristics in the picture. For example, a two-dimensional frequency transform such as a discrete cosine transform that is used for video encoding such as MPEG is applied to an image. Then, if energy exists up to a relatively high frequency band, this means that a minute texture and edge has been expressed, so that it can be estimated that no blur is included in the picture. On the other hand, if energy exists only in a relatively low frequency band, it can be estimated that the texture and edge is blurred.

FIG. 4 is a view showing a concept of determining whether blur exists. An input frame is divided into N×M blocks, and a two-dimensional frequency transform is applied to each block. After the two-dimensional frequency transform of each block, if energy exists up to high frequency bands in consideration of the overall picture, it is estimated that the video was shot by a professional cameraman without blur, and if energy exists only in low frequency bands, it is estimated that the video was shot by an amateur with blur.

FIG. 5 is a flowchart showing an example of a process of determining whether blur exists. First, a frame n is inputted (S50), a picture thereof is divided into N×M blocks (S51), and a two-dimensional frequency transform is applied to each of the divided blocks (S52).

Next, after initial setting (S53) of the number of blocks cb and the block number m to 0, respectively, an m-th block is inputted (S54), and it is determined whether energy exists in high frequency bands of this block (S55). Also, the high frequency bands for which determination is carried out is preset as one to define a boundary as to whether blur exists. It is also preferable that this is made variable. When it is determined in S55 that the energy in a high frequency bands of the block is equal to or less than a predetermined value, cb is incremented by one (cb=cb+1) (S56)

When it is determined in S55 that the energy in high frequency bands of the block exceeds a predetermined value and after the process of S56 is completed, it is determined whether m has reached N×M (S57).

When it is determined in S57 that m has not reached N×M, since an undetermined block still remains in the picture, m is incremented by one (m=m+1) (S58), and the flow returns to S54 to repeat the process.

When it is determined in S57 that m has reached N×M, since a determination of all blocks in the picture has been completed, a ratio of blocks having a predetermined value or less of energy in the high frequency bands to the number of all blocks in the picture (cb/(N×M)) is determined, and it is determined whether this ratio is greater than a fifth threshold value Th5 (S59). The fifth threshold value Th5 can be provided as, for example, 0.75 (75%).

When it is determined in S59 that cb/(N×M)>Th5, the frame n is determined to be a blurred image (S60), and when not determined so, the frame n is not determined to be a blurred image.

The contrast measuring unit 14 measures contrast of the picture in a video. Since the picture contrast is increased when a subject is shot with a high-performance camera such as a professional-quality camera or when shooting is performed with use of auxiliary light, it is highly likely that the video with a high picture contrast is a video shot by a professional cameraman. Therefore, the picture contrast can also be used for estimating whether the video was shot by a professional cameraman or was shot by an amateur.

For the measurement of picture contrast, such a technique as disclosed in Japanese Translation of International Application No. 2005-533424 can be used.

The video classifying unit 2 estimates, based on the analysis results obtained by the shot density measuring unit 11, the camera-shake determining unit 12, the blur determining unit, and the contrast measuring unit 14, whether the input video is one shot by a professional cameraman or one shot by an amateur to carry out classification. Since the shot density and whether camera shake exists are particularly effective in determination of a video, at least one of the analysis results of the shot density measuring unit 11 and the camera-shake determining unit 12 is necessary.

For example, when at least one of the conditions that (1) the shot density measured by the shot density measuring unit 11 is equal to or less than a certain value and (2) it is determined by the camera-shake determining unit 12 that camera shake exists is satisfied and further additionally, when the conditions that (3) it is determined by the blur determining unit 13 that blur exists and (4) the contrast in the picture measured by the contrast measuring unit 14 has a value equal to or less than a certain value are satisfied, the video classifying unit 2 estimates that the input video is one shot by an amateur to carry out classification.

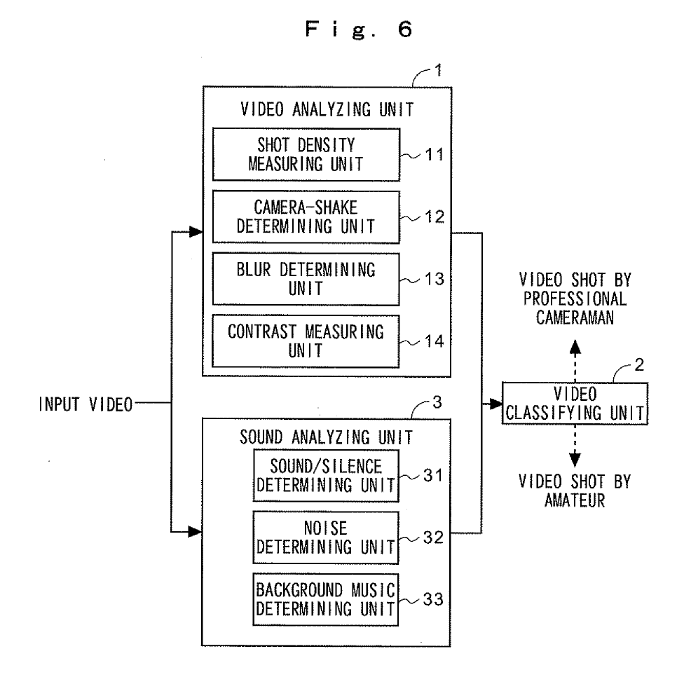

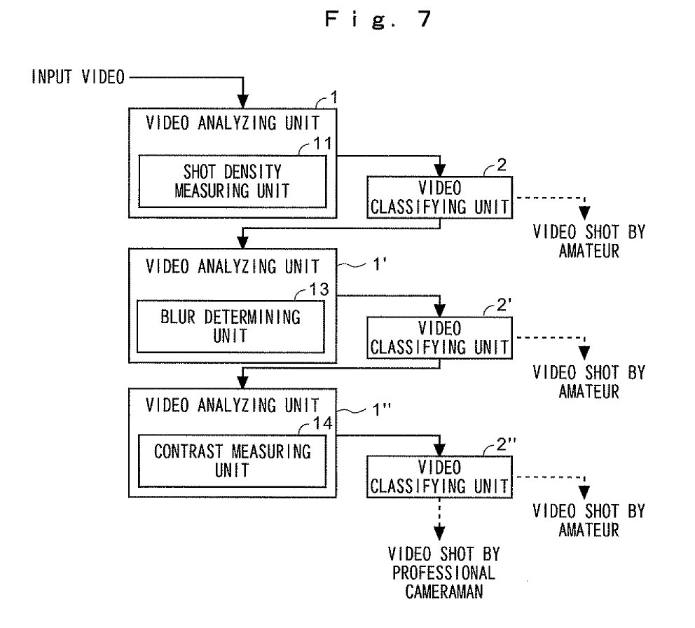

FIG. 6 is a functional block diagram showing a second embodiment of a video classifying device according to the present invention. The video classifying device of the second embodiment includes a sound analyzing unit 3 besides the video analyzing unit 1 provided in the first embodiment, whereby information for estimating whether the video was shot by a professional cameraman or was shot by an amateur is increased to make it possible to further improve classifying accuracy.

The video analyzing unit 1 is the same as that of the first embodiment in configuration and operation, and thus description thereof will be omitted. The sound analyzing unit 3 analyzes sound features accompanying an input video. The video classifying unit 2 estimates, based on analysis results of both the video analyzing unit 1 and sound analyzing unit 3, whether the input video is one shot by a professional cameraman or one shot by an amateur to carry out classification. Also, it is preferable that the input video can be classified based on the analysis results of only the video analyzing unit 1 when the input video is not accompanied by a sound.

The sound analyzing unit 3 includes a sound/silence determining unit 31, a noise determining unit 32, and a background music determining unit 33. Hereinafter, the respective units will be described in detail.

The sound/silence determining unit 31 determines whether a sound accompanying a video exists. Most of the videos shot by professional cameramen usually include sound except in the cases where these are intentionally made silent. On the other hand, a video shot by an amateur can be silent even without an intention. Therefore, it is highly likely that the silent video is a video shot by an amateur, and whether a sound accompanying a video exists can be used for estimating whether the video was shot by a professional cameraman or was shot by an amateur. Also, for the determination as to whether a sound exists, such a technique as disclosed in Japanese Patent Registration No. 3607450 can be used.

The noise determining unit 32 determines whether a sound accompanying a video is noise. Since noise occurs when an unwanted environmental sound and/or a voice unrelated with a subject is unintentionally recorded when shooting a video or when recording is carried out by use of a low-performance microphone, it is highly likely that the video accompanied by noise is a video shot by an amateur. Therefore, whether a sound accompanying a video is noise can also be used for estimating whether the video was shot by a professional cameraman or was shot by an amateur. Also, for the determination as to whether noise exists, such a technique as disclosed in Japanese Published Unexamined Patent Application No. H05-297896 can be used.

The background music determining unit 33 determines whether a sound accompanying a video is background music. Since background music is often inserted by editing after shooting, it is highly likely that the video accompanied by background music is a video shot by a professional cameraman. Therefore, whether a sound accompanying a video is background music can also be used for estimating whether the video was shot by a professional cameraman or was shot by an amateur. Also, for the determination as to whether background music exists, such a technique as disclosed in Japanese Patent Registration No. 3607450 can be used.

The video classitying unit 2 estimates, by use of the analysis results obtained by the sound/silence determining unit 31, the noise determining unit 32, and the background music determining unit 33 of the sound analyzing unit 3 besides the analysis results obtained by the video analyzing unit 1, whether the input video is one shot by a professional cameraman or one shot by an amateur to carry out classification.

For example, when the conditions that (5) a sound does not exist, (6) noise is observed in the sound, and (7) the sound does not include background music are satisfied, the video classifying unit 2 can estimate that the input video is a video shot by an amateur to carry out classification.

FIG. 7 is a functional block diagram showing a third embodiment of a video classifying device according to the present invention. For the video classifying device of the third embodiment, Z (Z: an integer equal to or more than 2) video analyzing units are connected in series. The respective video analyzing units analyze different features of an input video. Whether the input video is one shot by an amateur is determined based on results of ananalysis by each video analyzing unit, and when it is estimated that the input video is one shot by an amateur, the input video is classified at that stage as one shot by an amateur.

In FIG. 7, a video analyzing unit 1 including a shot density measuring unit 11, a video analyzing unit 1′ including a blur determining unit 13, and a video analyzing unit 1″ including a contrast measuring unit 14 are connected in series (Z=3) Video classifying units 2, 2′, and 2″ estimate whether the input video is one shot by an amateur based on results of an analysis by the video analyzing units 1, 1′ and 1″, respectively, and classify the input video as one shot by an amateur if it is estimated that the input video is one shot by an amateur. The video classifying unit 2″ classifies an input video not classified as one shot by an amateur as one shot by a professional cameraman.

In the third embodiment, since videos that are estimated to have been shot by professional cameramen are narrowed down step-by-step, videos to be processed in latter steps are gradually reduced. This allows for expecting a reduction in the processing load.

Although the embodiments have been described in the above, the present invention is not limited to the above embodiments but can be variously modified. For example, the video classifying units 2, 2′, and 2″ of the third embodiment can be provided as ones that estimate and classify a video shot by a professional cameraman so that a video not classified so far is classified by the video classifying unit 2″ as one shot by an amateur.

Moreover, classification criteria as to whether an input video is one shot by a professional cameraman or one shot by an amateur can also be set by learning features of videos shot by professional cameramen and features of videos shot by amateurs in advance and using classification criteria set based on that learning. That is, a learning machine that has been made to learn, in advance, behavior of the shot density, whether camera shake exists, whether blur exists, and contrast in a video shot by a professional cameraman and behavior of those in a video shot by an amateur can also be used as the video classifying unit 2 (2′, 2″). As the learning machine, Support Vector Machine and the like can be used.

Furthermore, it is also possible to make this learning machine learn, in advance, behavior of whether a sound exists, whether noise exists, and whether background music exists in a video shot by a professional cameraman and behavior of those in a video shot by an amateur.

What is claimed is:

1. A video classifying device comprising:
a video analyzing means that analyzes features of an input video; and
a video classifying means that estimates, based on results of an analysis by the video analyzing means, whether the input video is one shot by a professional cameraman or one shot by an amateur to carry out classification, wherein
the video analyzing means includes at least one of a shot density measuring means that measures a shot density in the input video and a camera-shake determining means that determines whether camera shake exists.

2. The video classifying device according to claim 1, wherein the video analyzing means further includes at least one of a blur determining means that determines whether blur of a picture exists and a contrast measuring means that measures contrast.

3. The video classifying device according to claim 1, wherein the video analyzing means includes the shot density measuring means, and the shot density measuring means consists of a means that detects shot boundaries and a means that counts a number of shots thus detected per unit time.

4. The video classifying device according to claim 1, wherein the video analyzing means includes the camera-shake determining means, and the camera-shake determining means assesses a motion direction and a motion magnitude between an input frame and a frame temporally ahead of the input frame and determines that camera shake exists, when a number of observed frames that satisfy a condition that a distribution of motion directions is smaller than a present first threshold value and satisfy at least one of the conditions that an average of motion magnitudes is smaller than a preset second threshold value and a distribution of motion magnitudes is smaller than a preset third threshold exceeds a preset fourth threshold value.

5. The video classifying device according to claim 2, wherein the video analyzing means includes the blur determining means, and the blur determining means applies a two-dimensional frequency transform to each of the blocks obtained by dividing the picture into a plurality of blocks and determines that blur exists, when a ratio of the number of blocks having a predetermined value or less of energy in a preset high frequency band to the number of all blocks is greater than a preset fifth threshold value.

6. The video classifying device according to claim 1, wherein the video analyzing means includes both the shot density measuring means and the camera-shake determining means, and the video classifying means estimates, when the shot density measured by the shot density measuring means is equal to or more than a predetermined threshold value per unit time and it is determined by the camera-shake determining means that no camera shake exists, that the input video is one shot by a professional cameraman to carry out classification.

7. The video classifying device according to claim 2, wherein the video analyzing means includes at least one of the shot density measuring means and the camera-shake determining means and at least one of the blur determining means and the contrast measuring means, and the video classifying means estimates, when it is determined by at least one of the shot density measuring means and the camera-shake determining means that the shot density is equal to or more than a predetermined threshold value per unit time or no camera shake exists and it is determined by at least one of the blur determining means and the contrast measuring means that no blur exists or the contrast is equal to or more than a predetermined threshold value, that the input video is one shot by a professional cameraman to carry out classification.

8. The video classifying device according to claim 1, further comprising a sound analyzing means that analyzes features of a sound accompanying the input video, wherein the video classifying means estimates, using results of an analysis by the sound analyzing means besides the results of an analysis by the video analyzing means, whether the input video is one shot by a professional cameraman or an amateur to carry out classification.

9. The video classifying device according to claim 8, wherein the sound analyzing means includes at least one of a sound/silence determining means that determines whether a sound exists, a noise determining means that determines whether noise exists, and a background music determining means that determines whether background music exists.

10. The video classifying device according to claim 9, wherein the sound analyzing means includes the noise determining means, and the noise determining means determines, when having detected that a sound exists and having classified the sound as noise, that noise exists.

11. The video classifying device according to claim 9, wherein the sound analyzing means includes the background music determining means, and the background music determining means determines, when having detected that a sound exists and having classified the sound as noise, that background music exists.

12. The video classifying device according to claim 9, wherein the sound analyzing means includes the sound/silence determining means, and the video classifying means estimates, when it is judged by the sound/silence determining means that the sound accompanying the input video does not exist in a previously specified time interval, that the input video is one shot by an amateur to carry out classification.

13. The video classifying device according to claim 10, wherein the video classifying means estimates, when it is determined by the noise determining means that the sound accompanying the input video includes noise, that the input video is one shot by an amateur to carry out classification.

14. The video classifying device according to claim 11, wherein the video classifying means estimates, when it is determined by the background music determining means that the sound accompanying the input video includes background music, that the input video is one shot by a professional cameraman to carry out classification.

15. The video classifying device according to claim 1, wherein the video classifying means is a learning machine in which classification criteria of video features for classifying the input video as one shot by a professional cameraman or one shot by an amateur are preset by learning.

16. The video classifying device according to claim 8, wherein the video classifying means is a learning machine in which classification criteria of video features and sound features for classifying the input video as one shot by a professional cameraman or one shot by an amateur are preset by learning.
